(19) United States
(12) Patent Application Publication
(10) Pub. No.: US 2003/0224225 A1
(43) Pub. Date: Dec. 4, 2003

(54) Method of transferring hydrogen gas in PEM fuel cell system and assembly of hydrogen atom

(76) Inventor: Judd McManus, Higganum, CT (US)

Correspondence Address: Judd McManus, 280 Hidden Lake Rd, Higganum, CT, 06441, US

(21) Appl. No.: 10/157,675

(22) Filed: May 29, 2002

(51) Int. Cl. H01M 8/00

(52) U.S. Cl. 429/10; 429/13

(57) ABSTRACT

A method of transferring hydrogen gas in PEM fuel cell systems and assembly of hydrogen atoms is presented. The operation of PEM fuel cells to produce electricity is of great value and offers much promise for the future. PEM fuel cell systems have traditionally operated using hydrogen and oxygen/air to produce electricity, heat, and water through an electrochemical reaction between hydrogen gas and oxygen/air.

While PEM fuel cell systems do offer many benefits, the historical use of oxygen/air and subsequent reaction between hydrogen and oxygen/air to form water can be viewed as a negative in many situations.

By preventing the reaction between hydrogen and oxygen/air, the invented method allows us to begin with hydrogen gas, use the hydrogen gas for a useful purpose via a PEM fuel cell, and end with hydrogen gas.

Through the invented method, PEM fuel cell systems can now operate in an entirely new way with many beneficial results.

The invented method allows us to begin with hydrogen gas, use the hydrogen gas for a useful purpose, and end with hydrogen gas. Through the invented method we are now able to position a hydrogen atom by using pressure, split the hydrogen atom into a proton and electron, use the proton and electron for a useful purpose, and end with a hydrogen atom. By following the steps of the invented method we are able to position an atom by using pressure, split the atom into sub-atomic particles, and use the subatomic particles to form an atom.

### BACKGROUND OF THE INVENTION

This invention relates to the transfer of hydrogen gas in PEM fuel cell systems and assembly of hydrogen atoms.

In the past, PEM fuel cell systems have operated using hydrogen and oxygen/air to produce electricity, heat, and water. In a traditional setup, hydrogen gas is supplied to the anode and oxygen is supplied to the cathode.

“At the anode, hydrogen molecules are oxidized to positively charged hydrogen ions, releasing electrons. The hydrogen ions diffuse through the ion-conducting polymer electrolyte membrane to the cathode. At the cathode, the hydrogen ions react with oxygen and the electrons supplied via the external circuit, forming water.” _{(Chemistry through Hydrogen—heliocentris—page} 90)

While the operation of PEM fuel cells to produce electricity is of great value and offers much promise for the future, the historical use of oxygen/air and subsequent reaction between hydrogen and oxygen/air to form water can be viewed as a negative in many situations.

Accordingly, it is an object of this invention to provide a new method of transferring hydrogen gas in PEM fuel cell systems and assembly of hydrogen atoms. By preventing the reaction between hydrogen and oxygen/air, the invented method allows us to begin with hydrogen gas, use the hydrogen gas for a useful purpose via a PEM fuel cell, and end with hydrogen gas. Through the invented method, PEM fuel cell systems can now operate in an entirely new way with many beneficial results.

### BRIEF SUMMARY OF THE INVENTION

The invented method of transferring hydrogen gas in PEM fuel cell systems and assembly of hydrogen atoms is configured to include hydrogen gas, a PEM fuel cell, liquid container, gas container, transport piping, water, and pressure.

Through the invented method hydrogen gas is supplied to a PEM fuel cell by using pressure. As hydrogen molecules come into contact with platinum coating on the proton-conductive polymer electrolyte membrane/proton exchange membrane of the PEM fuel cell, molecules separate into single atoms. The membrane splits atom into a proton and electron by allowing the proton to pass through the membrane and blocking the electron. Electrons travel through an external electrical circuit where they can be used to perform work. The proton and free electron end up on the same side of the membrane. The proton and free electron are then able to combine using magnetic energy to form a hydrogen atom. The invented method removes oxygen/air and any other substance that would react with the hydrogen atom to form a different substance.

Through the invented method we are now able to use a PEM fuel cell to produce electricity by using pressure and magnetic energy instead of through an electrochemical reaction between hydrogen gas and oxygen/air. The invented method prevents the electrochemical reaction between hydrogen gas and oxygen/air by replacing the oxygen/air with water.

As the hydrogen atoms combine to form hydrogen molecules/gas, sufficient pressure is used to move the hydrogen gas through transport piping and into a gas container.

As an added benefit of the invented method, we are now able to produce an alternating electrical current by using sufficient pressure to transfer the hydrogen gas through a PEM fuel cell in one direction and then use sufficient pressure to transfer the hydrogen gas through a PEM fuel cell in the opposite direction

The invented method allows us to begin with hydrogen gas, use the hydrogen gas for a useful purpose, and end with hydrogen gas. Through the invented method we are now able to position a hydrogen atom by using pressure, split the hydrogen atom into a proton and electron, use the proton and electron for a useful purpose, and end with a hydrogen atom. By following the steps of the invented method we are able to position an atom by using pressure, split the atom into sub-atomic particles, and use the subatomic particles to form an atom.

### BRIEF DESCRIPTION OF DRAWING

FIG. 1—Sample configuration/setup to perform invented method

FIG. 2—Hydrogen gas transferred to gas container through invented method

### DETAILED DESCRIPTION OF THE INVENTION

The invented method of transferring hydrogen gas in PEM fuel cell systems and assembly of hydrogen atoms is configured to include hydrogen gas, a PEM fuel cell, liquid container, gas container, transport piping, water, and pressure.

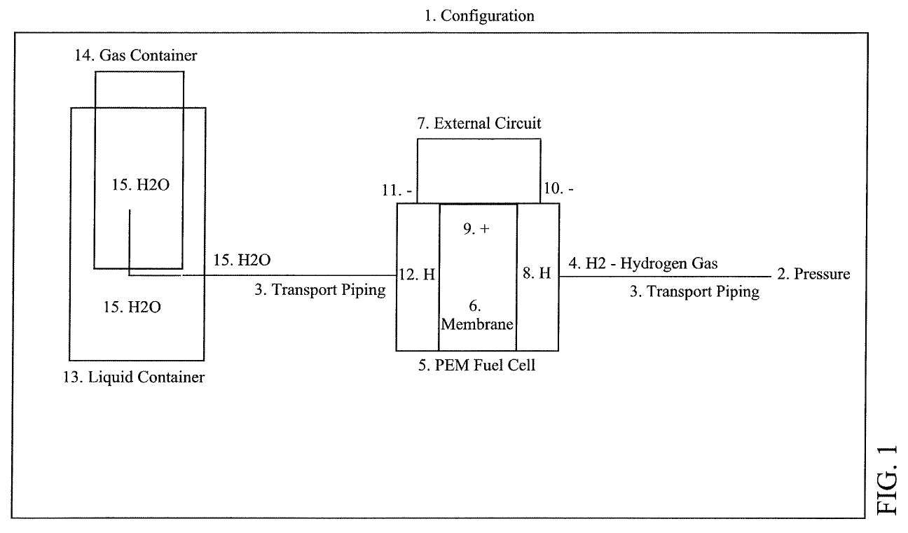

FIG. 1 shows a sample configuration (1) containing pressure (2), transport piping (3), hydrogen gas (4), PEM fuel cell (5), liquid container (13), gas container (14), and water/H2O (15).

To replicate the invented method we setup the configuration (1) as shown in FIG. 1. With the setup complete, we now supply hydrogen gas (4) to PEM fuel cell (5) via transport piping (3) by using pressure (2).

As hydrogen gas/molecules (4) come into contact with platinum coating on the proton-conductive polymer electrolyte membrane/proton exchange membrane (6) of the PEM fuel cell (5), molecules separate into single atoms (8). The membrane (6) splits atom (8) into a proton (9) and electron (10) by allowing the proton (9) to pass through the membrane (6) and blocking the electron (10). Electrons travel through external circuit (7) where they can be used to perform work

The proton (9) and free electron (11) end up on the same side of the membrane (6). The proton (9) and free electron (11) are then able to combine using magnetic energy to form hydrogen atom (12). Having water/H2O (15) initially in transport piping (3) as shown in FIG. 1 prevents the traditional electrochemical reaction between hydrogen gas and oxygen/air while releasing energy through PEM fuel cell (5).

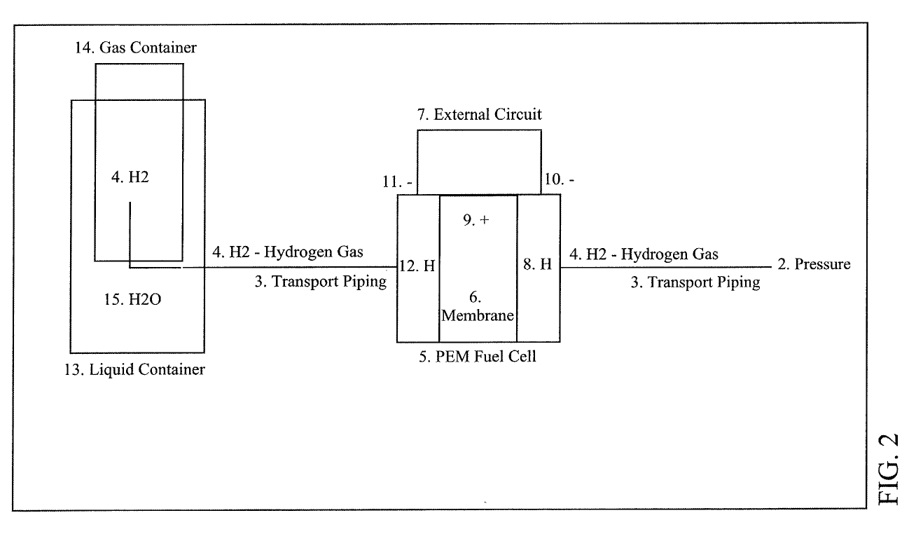

As more and more hydrogen gas (4) is supplied to PEM fuel cell (5) under pressure (2), transport piping (3), and gas container (14) will fill with hydrogen gas (4) as shown in FIG. 2.

By following the steps of the invented method and setting up the configuration (1) as shown in FIG. 1, we are able to begin with hydrogen (4) gas, use the hydrogen gas for a useful purpose, and end with hydrogen gas (4).

As demonstrated in FIGS. 1 and 2 we are now able to position a hydrogen atom (8) by using pressure (2), split the hydrogen atom (8) into a proton (9) and electron (10), use the proton (9) and electron (10/11) for a useful purpose, and end with a hydrogen atom (12). By following the steps of the invented method we are able to position an atom by using pressure, split the atom into sub-atomic particles, and use the sub-atomic particles to form an atom.

Although the above description contains many specifics, these should not be construed as limiting the scope of the invention, but as providing illustrations of some of the presently preferred embodiments of this invention.

Thus the scope of the invention should be determined by the appended claims and their legal equivalents, rather than by the example given.

I claim:

1. Method of transferring hydrogen gas in PEM fuel cell system while releasing energy comprising the supply of hydrogen gas to PEM fuel cell by using pressure, separating hydrogen molecules into single hydrogen atoms using catalyst, splitting hydrogen atom into proton and electron using proton-conductive polymer electrolyte membrane/proton exchange membrane, said proton passing through said membrane, electron traveling through external circuit, free electron ending on same side of said membrane as said proton, said proton and said free electron combining to form hydrogen atom through magnetic energy, eliminating oxygen/air and any other substance that would react with hydrogen atom to form different substance, whereby we can begin with hydrogen gas, use hydrogen gas for useful purpose, and end with hydrogen gas.

2. Method of producing electricity using PEM fuel cell system without electrochemical reaction between hydrogen gas and oxygen/air comprising the steps of claim 1, and replacement of oxygen/air with liquid, whereby PEM fuel cell system can produce electricity by using pressure and magnetic energy instead of through electrochemical reaction between hydrogen gas and oxygen/air.

3. Method of capturing hydrogen gas in PEM fuel cell system comprising the steps of claim 1, use of pressure, transport piping, and gas container, wherein sufficient pressure is used to move hydrogen gas through said transport piping to said gas container, whereby hydrogen gas can be stored for later use.

4. Method of producing alternating electrical current using PEM fuel cell system comprising the steps of claim 1 wherein sufficient pressure is used to transfer hydrogen gas through PEM fuel cell in one direction and sufficient pressure is then used to transfer hydrogen gas through said PEM fuel cell in opposite direction, whereby we can now produce alternating electrical current using PEM fuel cell system when desired.

5. Method of assembling hydrogen atom comprising the use of pressure to position hydrogen atom to come into contact with proton-conductive polymer electrolyte membrane/proton exchange membrane, splitting hydrogen atom into proton and electron using said membrane, said proton passing through said membrane, electron traveling through external circuit, free electron ending on same side of said membrane as said proton, said proton and said free electron combining to form hydrogen atom through magnetic energy, eliminating oxygen/air and any other substance that would react with hydrogen atom to form different substance, whereby we can begin with hydrogen atom, use hydrogen atom for useful purpose, and end with hydrogen atom.

6. Method of assembling atom comprising the use of pressure to position atom to come into contact with proton-conductive membrane, using said membrane to split atom into proton and electron, said proton passing through said membrane, electron traveling through external circuit, free electron ending on same side of said membrane as said proton, said proton and said free electron combining to form atom through magnetic energy, eliminating any substance that would react with desired atom to form different substance, whereby we can begin with atom, split atom into sub-atomic particles, and use sub-atomic particles to form atom.
